(19) United States
(12) Patent Application Publication
(10) Pub. No.: US 2023/0408987 A1
(43) Pub. Date: Dec. 21, 2023

(54) ARTIFICIAL INTELLIGENCE MODEL CONTROL SYSTEM

(71) Applicant: ASUSTeK COMPUTER INC., Taipei (TW)

(72) Inventors: Jia-En Lee, Taipei (TW); Shu-Chiao Liao, Taipei (TW)

(21) Appl. No.: 17/987,905

(22) Filed: Nov. 16, 2022

(30) Foreign Application Priority Data
May 17, 2022 (TW) 111118434

(51) Int. Cl. G05B 13/02

(52) U.S. Cl. CPC G05B 13/0265

(57) ABSTRACT

The disclosure provides an artificial intelligence model control system, including a plurality of artificial intelligence model service modules, a plurality of model plugins, and a model controller. Each model plugin corresponds to one artificial intelligence model service module, so that the model plugin communicates with the corresponding artificial intelligence model service module. The model controller is connected to the model plugins and controls, through the model plugin, the corresponding artificial intelligence model service module to perform a task. Therefore, in the disclosure, a single model controller controls all artificial intelligence model service modules to perform tasks.

### CROSS-REFERENCE TO RELATED APPLICATION

This application claims the priority benefit of Taiwan application serial No. 111118434, filed on May 17, 2022. The entirety of the above-mentioned patent application is hereby incorporated by reference herein and made a part of the specification.

### BACKGROUND OF THE INVENTION

### Field of the Invention

The disclosure relates to an artificial intelligence model control system that controls a plurality of artificial intelligence (AI) models by using plugins.

### Description of the Related Art

AI model draws conclusions by training data and algorithms, and when new data is inputted, makes a decision and takes an action by using the new data. When a plurality of AI models are deployed on a computer mainframe, the AI models individually call functions of training, verification, deployment, or inference through respective interfaces, such as an instruction of a terminal.

Each different AI model corresponds to a different interface design and language. For example, if the current AI model is a framework designed based on Python, a popular programming language nowadays, the corresponding model is called through Python to implement training, verification, deployment, or inference. If the current AI model is designed based on the programming language C++, an execution file or a dynamic link library is needed to implement training, verification, deployment, or inference. Each AI model needs to be controlled by its own control unit, and cannot be integrated.

### BRIEF SUMMARY OF THE INVENTION

According to the first aspect of this disclosure, an artificial intelligence model control system is provided. The artificial intelligence model control system includes a plurality of artificial intelligence model service modules, a plurality of model plugins, and a model controller. Each model plugin corresponds to one artificial intelligence model service module, so that the model plugin communicates with the corresponding artificial intelligence model service module. The model controller is connected to the model plugins, and controls, through the model plugin, the corresponding artificial intelligence model service module to perform a task.

According to the second aspect of this disclosure, an artificial intelligence model control system is provided. The artificial intelligence model control system includes at least one artificial intelligence model service module, at least one model plugin, and a model controller. The model plugin corresponds to the artificial intelligence model service module, so that the model plugin communicates with the artificial intelligence model service module. The model controller is connected to the model plugin, and the model controller controls, through the model plugin, the artificial intelligence model service module to perform a task.

In conclusion, the disclosure provides an artificial intelligence model control system that controls, by using a single model controller through interfaces defined by communication with various artificial intelligence models, each artificial intelligence model to perform a task such as training, verification, deployment or inference. In addition, in the disclosure, a plurality of artificial intelligence models of different types are operated simultaneously to perform respective tasks, so as to provide a larger variety of model operations. In addition, the interfaces of the disclosure are established in the form of plugins. By removing or adding a plugin, the model controller directly controls whether the artificial intelligence model is available or not.

### BRIEF DESCRIPTION OF THE DRAWINGS

FIG. 1 is a schematic block diagram of an artificial intelligence model control system according to an embodiment of the disclosure.

FIG. 2 is a schematic block diagram of an artificial intelligence model control system in which a third artificial intelligence model is disabled according to an embodiment of the disclosure.

FIG. 3 is a schematic block diagram of an artificial intelligence model control system deployed in a computer mainframe according to an embodiment of the disclosure.

FIG. 4 is a schematic block diagram of an artificial intelligence model control system deployed in different computers according to an embodiment of the disclosure.

### DETAILED DESCRIPTION OF THE EMBODIMENTS

Embodiments of the disclosure are described with reference to relevant drawings. In these drawings, identical reference numerals represent identical or similar elements or circuits. It should be understood that although the terms such as “first”, “second” are used to describe various elements, components, regions or functions in this specification, these elements, components, regions and/or functions are not restricted by these terms. These terms are only used to distinguish one element, component, region or function from another element, component, region or function.

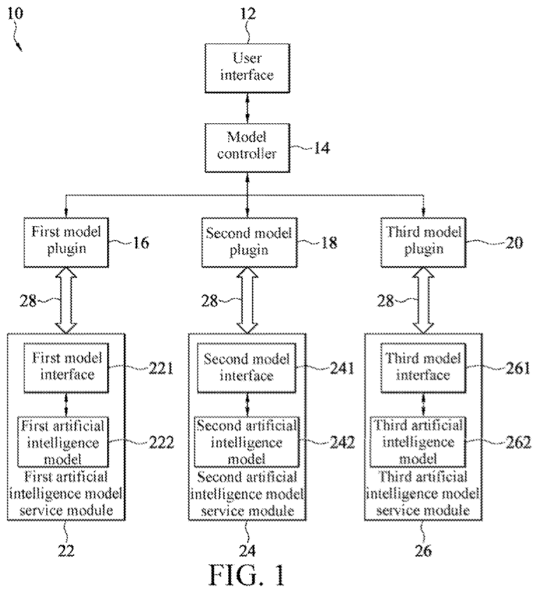

Referring to FIG. 1, an artificial intelligence model control system 10 includes a user interface 12, a model controller 14, a plurality of model plugins (this embodiment includes a first model plugin 16, a second model plugin 18, and a third model plugin 20), and a plurality of artificial intelligence model service modules (this embodiment includes a first artificial intelligence model service module 22, a second artificial intelligence model service module 24, and a third artificial intelligence model service module 26). Although three model plugins 16, 18, 20 and three artificial intelligence model service modules 22, 24, 26 are drawn in the drawings, the model plugins and the artificial intelligence model service modules in the disclosure are not limited to these quantities, as long as at least one model plugin and at least one artificial intelligence model service module are provided.

In the artificial intelligence model control system 10, the user interface 12 is connected to the model controller 14 so that data is provided to the model controller 14 through the user interface 12. In an embodiment, the user interface 12 marks training data or data to be tested and transmits the training data or the data to be tested to the model controller 14, or the user interface 12 converts the marked training data into a file format ready to be received, and then transmits the data to the model controller 14. The model controller 14 is connected to the first model plugin 16, the second model plugin 18, and the third model plugin 20. The first model plugin 16 corresponds to the first artificial intelligence model service module 22, so that the first model plugin 16 communicates with the corresponding first artificial intelligence model service module 22 through a Web application programming interface (API) 28. The second model plugin 18 corresponds to the second artificial intelligence model service module 24, so that the second model plugin 18 communicates with the corresponding second artificial intelligence model service module 24 through the Web API 28. The third model plugin 20 corresponds to the third artificial intelligence model service module 26, so that the third model plugin 20 communicates with the corresponding third artificial intelligence model service module 26 through the Web API 28. Based on this, the model controller 14 communicates with the first artificial intelligence model service module 22, the second artificial intelligence model service module 24, and the third artificial intelligence model service module 26 through the first model plugin 16, the second model plugin 18, and the third model plugin 20 respectively, thereby separately controlling each of the first artificial intelligence model service module 22, the second artificial intelligence model service module 24, and the third artificial intelligence model service module 26 to perform a task.

In an embodiment, the model controller 14 is bridged with the first model plugin 16 of the first artificial intelligence model service module 22 to form an independent dynamic link library (dll); the model controller 14 is bridged with the second model plugin 18 of the second artificial intelligence model service module 24 to form an independent dynamic link library; the model controller 14 is bridged with the third model plugin 20 of the third artificial intelligence model service module 26 to form an independent dynamic link library.

In an embodiment, the task performed by the first artificial intelligence model service module 22, the second artificial intelligence model service module 24, or the third artificial intelligence model service module 26 is training, verification, deployment, or inference.

The first artificial intelligence model service module 22 further includes a first model interface 221 and a first artificial intelligence model 222. The first model interface 221 establishes a corresponding transmission relationship with the corresponding first model plugin 16. The first artificial intelligence model 222 is connected to the first model interface 221 to communicate with the first model plugin 16 through the first model interface 221, so that the model controller 14 controls, through the first model plugin 16 and the first model interface 221, the first artificial intelligence model 222 to perform a task. The second artificial intelligence model service module 24 further includes a second model interface 241 and a second artificial intelligence model 242. The second model interface 241 establishes a corresponding transmission relationship with the corresponding second model plugin 18. The second artificial intelligence model 242 is connected to the second model interface 241 to communicate with the second model plugin 18 through the second model interface 241, so that the model controller 14 controls, through the second model plugin 18 and the second model interface 241, the second artificial intelligence model 242 to perform a task. The third artificial intelligence model service module 26 further includes a third model interface 261 and a third artificial intelligence model 262. The third model interface 261 establishes a corresponding transmission relationship with the corresponding third model plugin 20. The third artificial intelligence model 262 is connected to the third model interface 261 to communicate with the third model plugin 20 through the third model interface 261, so that the model controller 14 controls, through the third model plugin 20 and the third model interface 261, the third artificial intelligence model 262 to perform a task. Based on this, in the disclosure, the first model interface 221, the second model interface 241, and the third model interface 261 in the form of services are established on the original first artificial intelligence model 222, the second artificial intelligence model 242, and the third artificial intelligence model 262 respectively, to serve individual interfaces corresponding to the first model plugin 16, the second model plugin 18, and the third model plugin 20 respectively. In addition, according to the requirements of different first artificial intelligence models 222, parameters required for communication between the first model plugin 16 and the first model interface 221 through the Web API 28 are added or deleted. According to the requirements of different second artificial intelligence models 242, parameters required for communication between the second model plugin 18 and the second model interface 241 through the Web API 28 are added or deleted. According to the requirements of different third artificial intelligence models 262, parameters required for communication between the third model plugin 20 and the third model interface 261 through the Web API 28 are added or deleted.

As shown in FIG. 1, using the first model plugin 16 and the first artificial intelligence model service module 22 as an example, the first model plugin 16 generates a request according to an instruction of the model controller 14 and transmits the request to the first model interface 221 in the corresponding first artificial intelligence model service module 22 through the Web API 28. After format conversion performed by the first model interface 221, the request is transmitted to the first artificial intelligence model 222, so that the first artificial intelligence model 222 executes the request. The first artificial intelligence model 222 generates a response according to a result of execution of the request, and then the request is returned to the model controller 14 through the first model interface 221, the Web API 28, and the first model plugin 16, so that the model controller 14 obtains a state or result of execution of the request by the first artificial intelligence model 222.

In other words, at the beginning of an operation stage, the model controller 14 first turns on the first artificial intelligence model service module 22 to be used. When the task of training, verification, deployment, or inference needs to be performed, the model controller 14 calls a function in the first model plugin 16, transmits an operation starting request and parameters to the first artificial intelligence model service module 22 through the Web API 28, and determines whether the request succeeds according to a response transmitted by the first artificial intelligence model service module 22. When the operation needs to be suspended, the model controller 14 calls a function in the first model plugin 16, transmits an operation stopping request to the first artificial intelligence model service module 22 through the Web API 28, and determines whether the request succeeds according to a response transmitted by the first artificial intelligence model service module 22. In the process of operation, the model controller 14 is allowed to call a function in the first model plugin 16 at any time, transmits a state obtaining request to the first artificial intelligence model service module 22 through the Web API 28, and obtains a current operating state according to a response transmitted by the first artificial intelligence model service module 22. Similarly, the second artificial intelligence model service module 24 and the third artificial intelligence model service module 26 also perform the same operation.

In an embodiment, the request is to disable a service of the artificial intelligence model, obtain a state of the artificial intelligence model service, start training of the artificial intelligence model, stop training of the artificial intelligence model, obtain a state and result during training of the artificial intelligence model, start verification of the artificial intelligence model, stop verification of the artificial intelligence model, obtain a state and result during verification of the artificial intelligence model, cause the artificial intelligence model to start outputting a model file to be deployed, cause the artificial intelligence model to stop outputting a model file to be deployed, obtain a state of model file outputting of the artificial intelligence model, cause the artificial intelligence model to start inference based on a model file deployed, cause the artificial intelligence model to stop inference, or obtain an inference state the artificial intelligence model, but the disclosure is not limited to thereto, and control functions are added as required.

As shown in FIG. 1, when a new artificial intelligence model needs to be added, taking the third artificial intelligence model 262 as an example, the third artificial intelligence model 262 is directly added to the artificial intelligence model control system 10 as long as the third model plugin 20 is added and the third model interface 261 is established to communicate with the third artificial intelligence model 262. The shared model controller 14 directly controls the third artificial intelligence model 262 to perform the task.

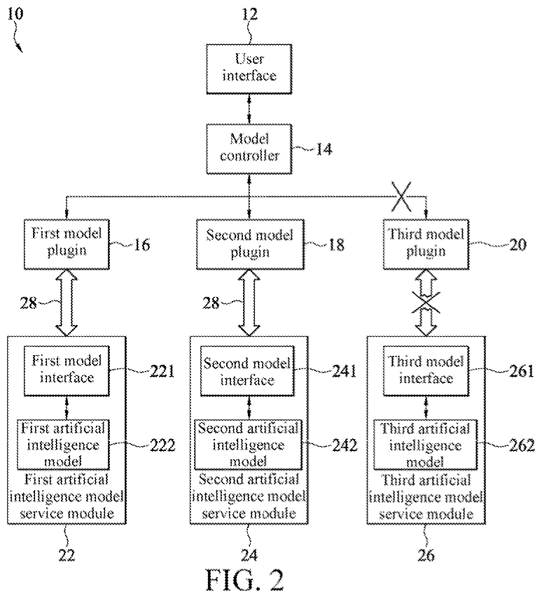

As shown in FIG. 2, if a specific artificial intelligence model needs to be disabled, taking the third artificial intelligence model 262 as an example, the third artificial intelligence model 262 (the third artificial intelligence model service module 26) is directly disabled in the model controller 14, so that the model controller 14 and the third model plugin 20 are not connected. In addition, if the specific artificial intelligence model needs to be disabled at the beginning, taking the third artificial intelligence model 262 as an example, the dynamic link library corresponding to the third model plugin 20 is not installed.

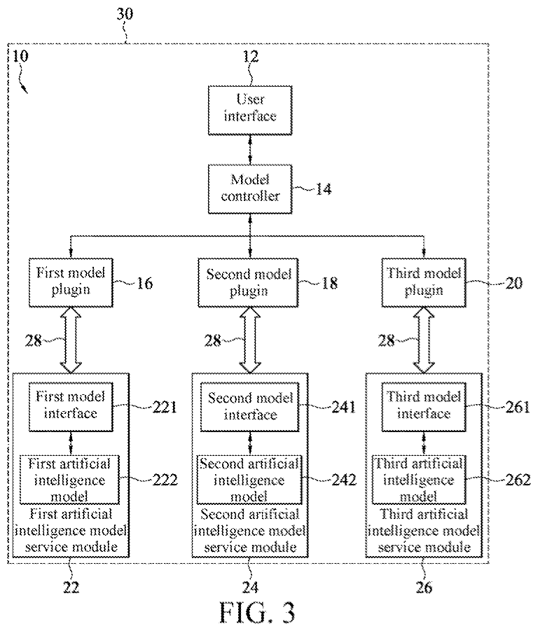

In an embodiment, referring to FIG. 3, in the artificial intelligence model control system 10, the model controller 14, the first model plugin 16, the second model plugin 18, the third model plugin 20, the first artificial intelligence model service module 22, the second artificial intelligence model service module 24, and the third artificial intelligence model service module 26 are deployed in the same computer mainframe 30. Therefore, when the first model plugin 16, the second model plugin 18, and the third model plugin 20 communicate with the first artificial intelligence model service module 22, the second artificial intelligence model service module 24, and the third artificial intelligence model service module 26 respectively, it is also possible to implement communication by using an existing command transmission mode in addition to the Web API 28 of the HTTP communication protocol.

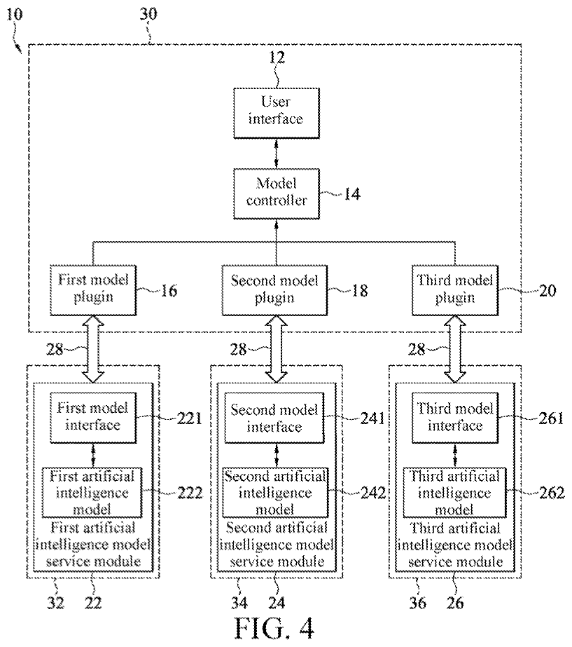

In another embodiment, referring to FIG. 4, in the artificial intelligence model control system 10, the model controller 14, the first model plugin 16, the second model plugin 18, and the third model plugin 20 are deployed in the same computer mainframe 30, but the first artificial intelligence model service module 22, the second artificial intelligence model service module 24, and the third artificial intelligence model service module 26 are deployed in different computers. That is, the first artificial intelligence model service module 22 is deployed in a first computer 32, the second artificial intelligence model service module 24 is deployed in a second computer 34, and the third artificial intelligence model service module 26 is deployed in a third computer 36. The first model plugin 16, the second model plugin 18, and the third model plugin 20 communicate with the first artificial intelligence model service module 22, the second artificial intelligence model service module 24, and the third artificial intelligence model service module 26 respectively through the Web API 28 of the HTTP communication protocol. Therefore, in the disclosure, the first artificial intelligence model 222, the second artificial intelligence model 242, and the third artificial intelligence model 262 perform different tasks in the first computer 32, the second computer 34, and the third computer 36 through the model controller 14. In an embodiment, the model controller 14 controls the first artificial intelligence model 222 in the first computer 32 to perform a model training task. In addition, the model controller 14 controls the second artificial intelligence model 242 in the second computer 34 to perform an inference task. Therefore, when the first artificial intelligence model 222 performs a task on the first computer 32, the second artificial intelligence model 242 and the third artificial intelligence model 262 run the same task or different other tasks in parallel on the second computer 34 and the third computer 36.

In conclusion, the disclosure provides an artificial intelligence model control system that controls, by using a single model controller through interfaces defined by communication with various artificial intelligence models, each artificial intelligence model to perform a task such as training, verification, deployment or inference. In addition, in the disclosure, a plurality of artificial intelligence models of different types are operated simultaneously to perform respective tasks, so as to provide a larger variety of model operations. In addition, the interface of the disclosure is established in the form of plugin. Through the removal and addition of the plugin, the model controller directly controls whether the artificial intelligence model is used.

The foregoing embodiments are merely for describing the technical ideas and the characteristics of the disclosure, and are intended to enable those skilled in the art to understand and hereby implement the content of the disclosure. However, the scope of claims of the disclosure is not limited thereto. In other words, equivalent changes or modifications made according to the spirit disclosed in the disclosure shall still fall into scope of the claims of the disclosure.

What is claimed is:

1. An artificial intelligence model control system, comprising:
a plurality of artificial intelligence model service modules;
a plurality of model plugins, wherein each model plugin corresponds to one of the artificial intelligence model service modules, and the model plugin communicates with the corresponding artificial intelligence model service module; and
a model controller, connected to the model plugins and controlling, through the model plugin, the corresponding artificial intelligence model service module to perform a task.

2. The artificial intelligence model control system according to claim 1, wherein the model plugin generates a request for the corresponding artificial intelligence model service module according to an instruction of the model controller, so that the artificial intelligence model service module executes the request.

3. The artificial intelligence model control system according to claim 2, wherein the artificial intelligence model service module generates a response according to a result of execution of the request, and transmits the response to the model controller through the model plugin.

4. The artificial intelligence model control system according to claim 1, wherein the model plugin communicates with the artificial intelligence model service module through a Web application programming interface (API).

5. The artificial intelligence model control system according to claim 1, wherein each of the artificial intelligence model service modules further comprises:
a model interface, establishing a corresponding transmission relationship with the corresponding model plugin; and
an artificial intelligence model, connected to the model interface, wherein the artificial intelligence model communicates with the model plugin through the model interface, so that the model controller controls, through the model plugin and the model interface, the artificial intelligence model to perform the task.

6. The artificial intelligence model control system according to claim 1, wherein when a specific one of the artificial intelligence model service modules is disabled, the specific artificial intelligence model service module is directly disabled in the model controller, so that the model controller and the model plugin are not connected.

7. The artificial intelligence model control system according to claim 1, further comprising a user interface connected to the model controller, so that data is provided to the model controller through the user interface.

8. The artificial intelligence model control system according to claim 1, wherein each of the model plugins is an independent dynamic link library.

9. The artificial intelligence model control system according to claim 1, wherein the task is a training, a verification, a deployment, or an inference.

10. The artificial intelligence model control system according to claim 1, wherein the artificial intelligence model service modules are deployed in a same computer mainframe.

11. The artificial intelligence model control system according to claim 1, wherein the artificial intelligence model service modules are deployed in different computers.

12. An artificial intelligence model control system, comprising:
at least one artificial intelligence model service module;
at least one model plugin, wherein the model plugin corresponds to the artificial intelligence model service module and communicates with the artificial intelligence model service module; and
a model controller, connected to the model plugin and controlling, through the model plugin, the artificial intelligence model service module to perform a task.

13. The artificial intelligence model control system according to claim 12, wherein the model plugin generates a request for the corresponding artificial intelligence model service module according to an instruction of the model controller, so that the artificial intelligence model service module executes the request.

14. The artificial intelligence model control system according to claim 13, wherein the artificial intelligence model service module generates a response according to a result of execution of the request, and transmits the response to the model controller through the model plugin.

15. The artificial intelligence model control system according to claim 12, wherein the model plugin communicates with the artificial intelligence model service module through a Web application programming interface (API).

16. The artificial intelligence model control system according to claim 12, wherein the artificial intelligence model service module further comprises:
a model interface, establishing a corresponding transmission relationship with the corresponding model plugin; and
an artificial intelligence model, wherein the artificial intelligence model is connected to the model interface and communicates with the model plugin through the model interface, so that the model controller controls, through the model plugin and the model interface, the artificial intelligence model to perform the task.

17. The artificial intelligence model control system according to claim 12, wherein when the artificial intelligence model service module is disabled, the artificial intelligence model service module is directly disabled in the model controller, so that the model controller and the model plugin are not connected.

18. The artificial intelligence model control system according to claim 12, further comprising a user interface connected to the model controller, so that data is provided to the model controller through the user interface.

19. The artificial intelligence model control system according to claim 12, wherein the model plugin is an independent dynamic link library.

20. The artificial intelligence model control system according to claim 12, wherein the task is a training, a verification, a deployment, or an inference.
